(19) United States
(12) Patent Application Publication
(10) Pub. No.: US 2006/0138090 A1
(43) Pub. Date: Jun. 29, 2006

(54) System and method for manufacturing steel tapered poles

(76) Inventor: Enrique Franco, Humble, TX (US)

Correspondence Address: SEYFARTH SHAW LLP, 55 E. MONROE STREET, SUITE 4200, CHICAGO, IL, 60603-5803, US

(21) Appl. No.: 11/022,629

(22) Filed: Dec. 27, 2004

(51) Int. Cl. B23K 9/02; B23K 9/00; B23K 31/02

(52) U.S. Cl. 219/60.2; 219/59.1; 228/170

(57) ABSTRACT

The present invention is related to a system and method for manufacturing steel tapered poles from previously cut and punched steel strips, which are arranged together on a mold and subsequently welding the steel strips on place as to form a substantially one piece tapered pole.

### BACKGROUND OF THE INVENTION

1. Field of the Invention

The present invention is related to a system and method for manufacturing steel tapered poles.

Steel tapered poles are cylindrical structures that can be built in many different lengths, diameters and sizes, depending on the type of application that it will be used for.

Tapered poles are made with high-strength low-alloy steel conforming to ASTM (American Society for Testing and Materials). Trapezoidal or triangular steel plaques are welded to form a multi-sided cylindrical structure. Welding should comply with the American Welding Society (AWS) standards. Poles normally have a finishing coating to protect them from corrosion; the different types of finishes are galvanizing, painting or self-weathering.

Tapered poles are designed in accordance with industry standards and/or end user specifications. The most common industry standards are ASTM, AWS and American Society of Civil Engineers (ASCE) standards.

Poles require far less land and have less foundation costs than other tower types. Moreover, poles require less maintenance because they have practically no associated hardware (bolts, screws, angles). They are better looking and less obtrusive structures in the skyline than other tower types.

Steel tapered poles can be used in a wide range of applications. Normal markets for these poles are:
Traffic and lighting. This segment includes all the structures to which lighting and traffic control structures are attached for a wide range of applications: streets, highways, parking lots, commercial and residential developments. Area lighting structures range in height from 90 to 150 feet; traffic structures range
Power transmission. Steel tapered poles can be used by utilities to transmit and distribute electricity to their customers. Power transmission poles can be divided into transmission, sub transmission and distribution poles depending on the voltage they carry. Transmission poles could carry 115 to 400 kilovolts (kV); sub transmission poles normally carry voltage in the 69 to 138 kV range, and distribution poles in the 13.8 to 34.5 kV range.

The difference between each one of these poles is the height of the structure and the type and size of attachments, special equipment mounting brackets and other accessories.
Telecommunications. In the telecoms industry, poles are used to support cellular transmitter and receiver devices. These structures range in height from 30 to 1000 feet.

These structures should be designed to meet customer specifications and site factors, which include the number of antennas on the structure, wind and soil conditions or geographical location. Due to the size of these structures, engineering and design procedures are extremely important factors to ensure that each structure meets performance and safety specifications.
Wind Power. Wind power structures generate electricity by harnessing the wind. These structures are composed of a wind turbine and the generator equipment. The wind turbine is mounted over a steel pole. These poles are wider in diameter and have an elliptic shape to provide adequate support against wind speeds. The steel used in these structures is thicker than in the other applications.

Steel tapered poles offer a variety of possibilities to end users:
Flexibility. Steel poles can be custom designed to support larger and heavier loadings with longer spans between structures, as well as meet greater height requirements. This means fewer poles to purchase and install. Industries that benefit: Utilities.
Easy-to-Use. The poles can be pre-drilled to accommodate special customer framing requirements and most existing hardware can easily be used on steel structures. Industries that benefit: Utilities, Lighting and Traffic.
Environmental: Steel poles comply with EPA regulations. Steel poles are non-toxic and recyclable, reducing disposal problems and costs. Industries that benefit: Utilities, Lighting and Traffic, Telecommunications.
Maintenance: Less hardware (bolts, screws) means less maintenance work to do. Steel is not susceptible to damage by external factors (animals, fires) like concrete or wood poles. Industries that benefit: Utilities.
Lead Time. Manufacturing time for poles is lower than for other types of structures meaning faster time to deploy; installation time is also lower thus saving labor costs. Industries that benefit: Utilities, telecommunications.

There are two broad segments where this development could be a meaningful advance.
Steel Tapered Pole Consumers. The consumers of these poles are the same that were mentioned in section Background of this document. They can get the following benefits:
   Lower Pole Manufacturing Costs. The cost saving advantages of the process might push manufacturers to lower their pole prices in benefit of end users.
   Lower lead time. The reduced lead time for the machinery allows manufacturers to start producing faster than before and cope with seasonal peaks of demand for the poles. Consumers won't have delays in the delivery of their goods.
Steel Pole Manufacturers. Pole manufacturers could get many advantages from this development:
   Lower investment in plant and equipment
   Faster time to start production (meaning faster return on investment)

Another application for this development is the following:
Structural applications. This development might be used to manufacture special tubes and piping for structural applications.

2. Description of the Prior Art

The standard manufacturing process of steel tapered poles comprises the following steps.
Steel plates are fed directly into CNC (Computer Numerical Control) controlled plasma burning equipment and cut to the required dimensions. The shape and measurements of this piece are designed accordingly with the application of the finished pole.
The cut piece is then fed into a large break press. The piece of sheet metal is formed along a straight axis. The resultant piece might be a “V”-shaped, “U”-shaped, or semi cylindrical shaped piece. The type of shape is determined by the punch and die set of the press.
Two or more of these semi cylindrical shapes are welded together to produce a complete cylindrical structure. Components should be pre-heated according to AWS code parameters and then welded either with MIG (metal in gas welding by micro wire) or submerged arc devices.
After welding, and depending on the choice of finish, poles could be coated with urethane powder, painted or galvanized. Galvanized is the most common finish for these structures.

### FEATURES OF THE INVENTION

The present manufacturing process has the following advantages:
Less investment in machinery. This new manufacturing process does not require some of the machines used in the traditional pole manufacturing industry such as a break press. These machines are replaced by the new equipment at a lower cost.
Less investment in plant. Traditional process for pole manufacturing requires large foundation works to place the press brakes. The new machinery saves costs in plant construction since it doesn't require any type of foundation to operate properly.
Lead time. Normal lead time for traditional machinery ranges from 12 to 15 months; lead time for the new machinery is 3 to 6 months. This reduced lead time translates into a faster return on investment since production can begin earlier.
The resultant tapered pole from the invention has the same structural behavior as the tapered pole from the break press process.

On the other hand, this manufacturing process has the following disadvantages:
Additional labor. This new process requires more labor than the traditional one, increasing associated costs (salaries, training).

### SUMMARY OF THE INVENTION

The present invention refers to a system and a method for the manufacturing of steel tapered poles. It consists in the manufacturing of steel tapered poles by placing previously cut and punched strips of steel into a rotating mold to form a pole. The strips of steel are fixed with bolts to the mold and then they are welded together, after welding is over, the bolts are removed, and the finished tapered pole is removed with and hydraulic extractor from the mold.

### DESCRIPTION OF THE DRAWINGS

FIG. 1 is a side view of the mold and the welding machine with all the pole section steel strips placed around the shaft of the mold.

FIG. 2 is a perspective view of the mold and the welding machine during the production process. Some strips of steel of the pole section are already in place around the shaft and there is one more strip of steel that is being lowered by the hoist; this strip will be fixed into the shaft of the mold and once all strips are on its place, they will be welded.

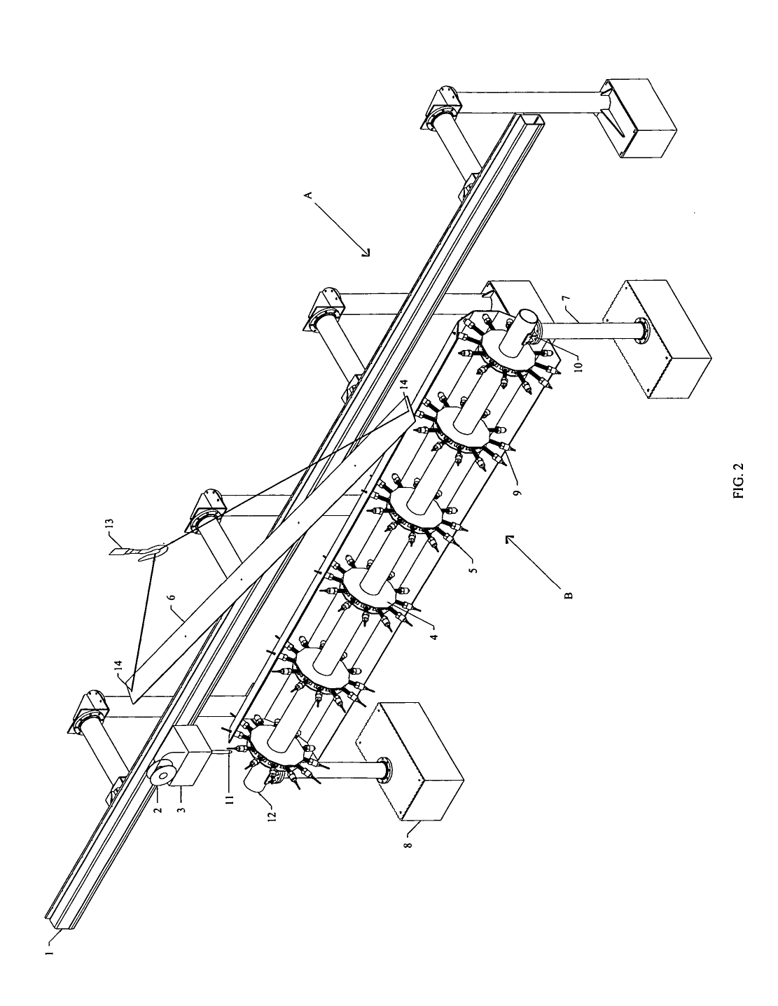

FIG. 3 is a perspective view of the mold and the welding machine with all the pole section steel strips placed around the shaft of the mold.

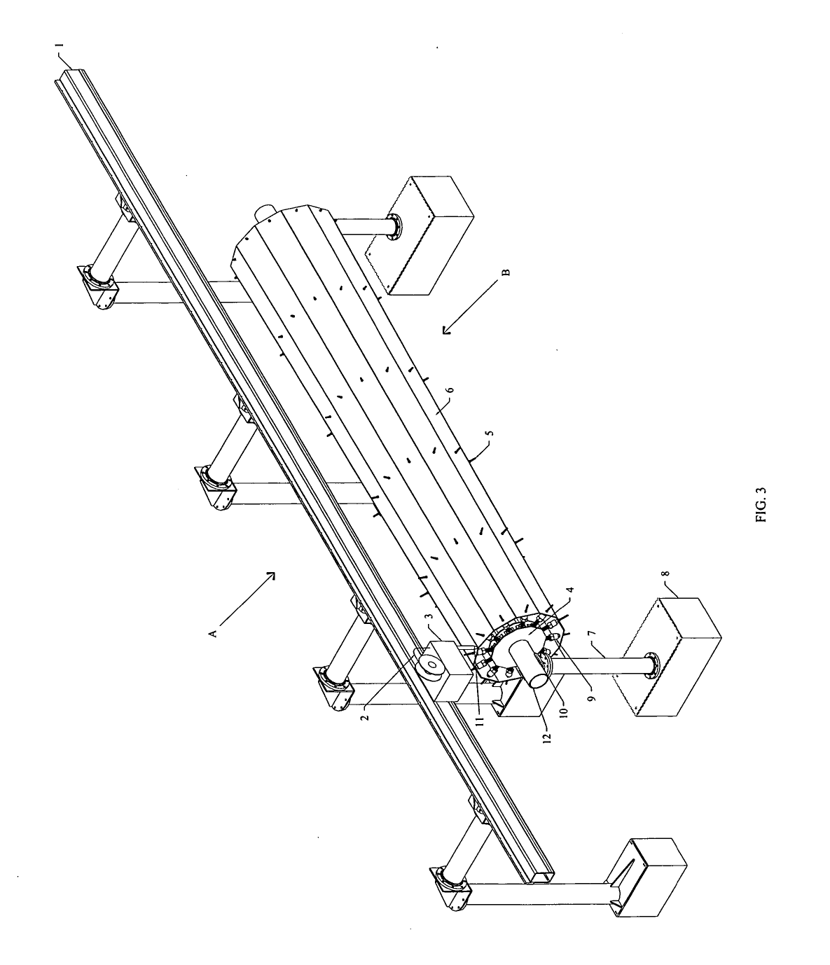

### DETAILED DESCRIPTION OF THE INVENTION

Detailed Description of the System:

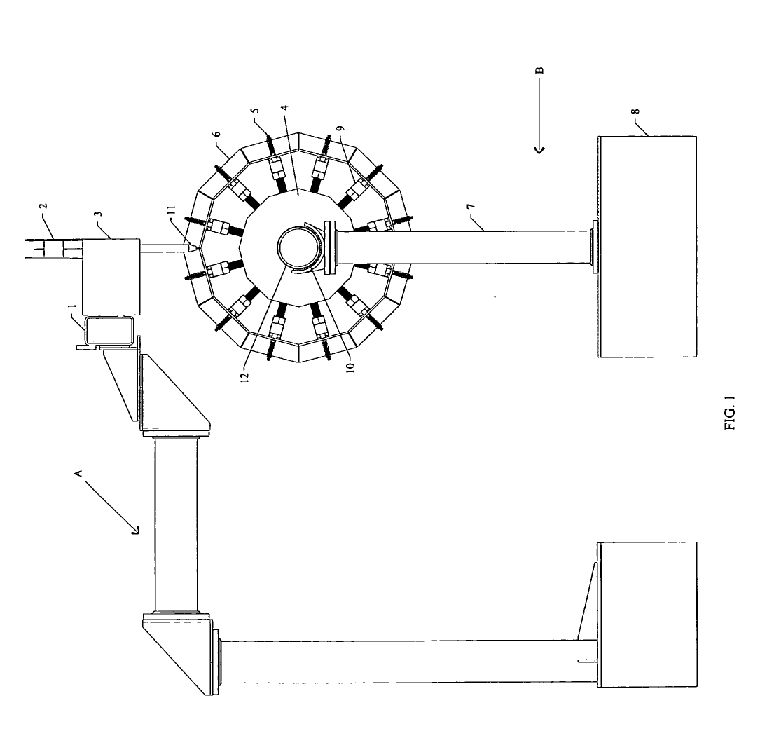

As can be seen in FIG. 1, The system is conformed of: a welding device (A) and a pole mold (B) located one in front of the other for operative interaction, for forming a steel pole on the mold from steel strips and welding together the steel strips.

The welding device (A) comprises a welding wire (2), a welding carriage (3) and a submerged arc welder (11). The welding device (A) device is slideably mounted on a submerged arc welding beam (1) to weld strips of steel together where needed.

In front of the welding device (A) there is located a pole mold (B) comprising a mold pipe (12), rotatable supported by a bearing (10) placed over a mold support (7) vertically extending upwards from a base (8). The mold pipe (12) holds a plurality of mold plates (4) distributed through out the length of the mold pipe. The pole mold (B) has a polygonal shape. The number of sides thereof is determined by the design of the steel pole; usually 12 and 18 sides are the standard, but any number of plates can be used to form a polygon.

In the front face of each mold plate (4) is placed an adjustable support (9) that holds a bolt (5) extending outwardly in a radial form to match the holding holes (14) of each of the steel strips (6) to be welded together.

Detailed Description of the Method.

Steel strips (6) are cut with plasma into a trapezoidal shape; the strips are punched to make the holding holes (14) to fit the pole mold (B).

Once all the steel strips (6) are cut and punched, they are placed in the mold (B) by means of a hoist (13). The steel strips (6) are arranged in such a form that the bolts (5) are inserted into the holding holes (14) of the steel strips (6) to hold them in their correct place.

Once all the steel strips (6) are correctly aligned by means of the adjustable supports (9) and fastened into place with the bolts (5) they are welded using a submerged arc welder (11).

After welding all the sides of the tapered pole, the bolts (5) are removed from the mold. When all bolts are removed the tapered pole is extracted from the mold utilizing and Hydraulic extractor.

The process described above is repeated to form different types (geometry) of poles; one mold is required for each type of tapered pole.

1. A system for manufacturing steel tapered poles from previously cut and punched steel strips, comprising:
a welding device (A) and a pole mold (B) located one in front of the other for operative interaction, for forming a steel pole on the mold from steel strips and welding together the steel strips;
the welding device (A) comprises a welding wire (2), a welding carriage (3) and a submerged arc welder (11); The welding device (A) device is slideably mounted on a submerged arc welding beam (1) to weld strips of steel together where needed;
in front of the welding device (A) there is located a pole mold (B) comprising a mold pipe (12), rotatable supported by a bearing (10) placed over a mold support (7) vertically extending upwards from a base (8); the mold pipe (12) holds a plurality of mold plates (4) distributed through out the length of the mold pipe.

2. a method for manufacturing steel tapered poles from previously cut and punched steel strips, comprising the steps of:
cutting steel strips (6) with plasma, into a trapezoidal shape;
punching the strips (6) as to make holding holes 14;
placing the previously cut and punched steel strips (6) over a mold (B) by means of a hoist (13);
arranging the steel strips (6) over the mold in such a form that the holding holes (14) are fit on upwardly projecting bolts (5) located in the front faces of mold plates (4) of the mold (B) to hold the steel strips (6) in their correct position for welding;
align all the steel strips (6) on the mold by means of adjustable supports (9);
fastening the steel strips (6) into place with the bolts (5);
welding together the steel strips (6) using a submerged arc welder (11) by rotating the mold sequentially;
removing the bolts (5) from the mold;
extracting the so formed steel tapered pole from the mold utilizing an hydraulic extractor.
